(19) United States
(12) Patent Application Publication
(10) Pub. No.: US 2003/0126719 A1
(43) Pub. Date: Jul. 10, 2003

(54) Anti-lock turning shaft for positive and reverse turning on a single element

(76) Inventor: Lin-Lin Chen, Hsien (TW)

Correspondence Address: BACON & THOMAS, PLLC, 625 SLATERS LANE, FOURTH FLOOR, ALEXANDRIA, VA, 22314

(21) Appl. No.: 10/035,169

(22) Filed: Jan. 4, 2002

(51) Int. Cl. E05D 11/08

(52) U.S. Cl. 16/342

(57) ABSTRACT

An anti-lock turning shaft for positive and reverse turning on a single element consists of a shaft body which has an anchor section connecting a spindle, and a sleeve which has a pivotal section coupling with the spindle. The pivotal section connects a first elastic section and a second elastic section. The first elastic section and the second elastic section form a positive and reverse turning on a single element to allow dynamic and static friction forces close to each other, and to allow gripping forces reaching a natural balance to increase useful life, and to generate a loose and a tight condition, thereby to prevent lock phenomenon from happening, and avoid the installation main body from damaging.

### FIELD OF THE INVENTION

The present invention relates to an anti-lock turning shaft for positive and reverse rotation on a single element, and particularly a turning shaft with a positive and a reverse turning elastic section located on the same element.

### BACKGROUND OF THE INVENTION

Most known notebook or handheld computers these days have the display screen and computer processor engaging through a pivotal means. When in use, users open the display screen, and the computer is ready for use. When not in use, the display screen and processor may be folded together to shrink the size to facilitate storing or carrying. The pivotal means mentioned above generally are embodied in the form of hinges. The hinges pivotally connect the display screen and the processor to allow the display screen unfolding or folding. A conventional hinge usually consists of a spindle and two sleeves pivotally coupling with the spindle. The spindle may be located on the display screen or on the processor body. The sleeves may also be located on the display screen or on the processor body. The configuration and arrangement of the spindle and sleeves are determined by producers. When the hinge is turning, two conditions occurred. The first condition is that the spindle remains stationary and the two sleeves turn. The second condition is that the spindle turns but the two sleeves remain stationary. Those designs tend to incur two ways frictional wearing and metal fatigue. When utilizing reciprocally for a long period of time, the gap between the spindle outside diameter and sleeve inner diameter will increase. As a result, when the display screen is unfolded or folded, a wobbling will occur, and an annoying friction noise will be generated.

### SUMMARY OF THE INVENTION

The primary object of the invention is to resolve aforesaid disadvantages. The invention employs a single element to accommodate positive and reverse turning to allow dynamic and static friction forces close to each other, and to allow gripping force reaching a natural balance, thereby to increase useful life. The structure of allowing positive and reverse turning incurred on a single element generates a loose and a tight condition, and can prevent lock phenomenon from happening. Thus the installation main body of the product may be free from damage.

Another object of the invention is to provide a simple and small size structure to make production simpler, and also to provide an anchor function to make adjusting the opening angle easier. Different torque of positive and reverse turning are control by the width of a positive and a reverse elastic blade.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the invention.

FIG. 2 is an extended view according to FIG. 1.

FIG. 3 is a cross section taken along line 3-3 in FIG. 1, showing an operating condition.

FIG. 4 is a cross section taken along line 4-4 in FIG. 1, showing another operating condition.

FIG. 5 is a schematic side view of a second embodiment of the invention.

FIG. 6 is a schematic side view of a third embodiment of the invention.

FIG. 7 is a schematic side view of a fourth embodiment of the invention.

FIG. 8 is a schematic side view of a fifth embodiment of the invention.

FIG. 9 is a schematic side view of a sixth embodiment of the invention.

FIG. 10 is a schematic side view of a seventh embodiment of the invention.

FIG. 11 is a schematic side view of an eighth embodiment of the invention.

### DESCRIPTION OF THE PREFERRED EMBODIMENTS

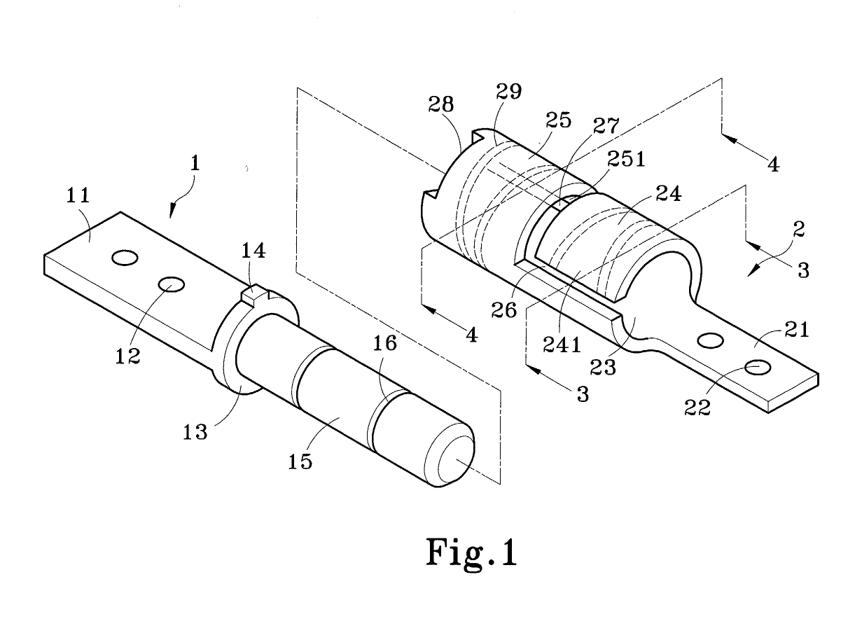

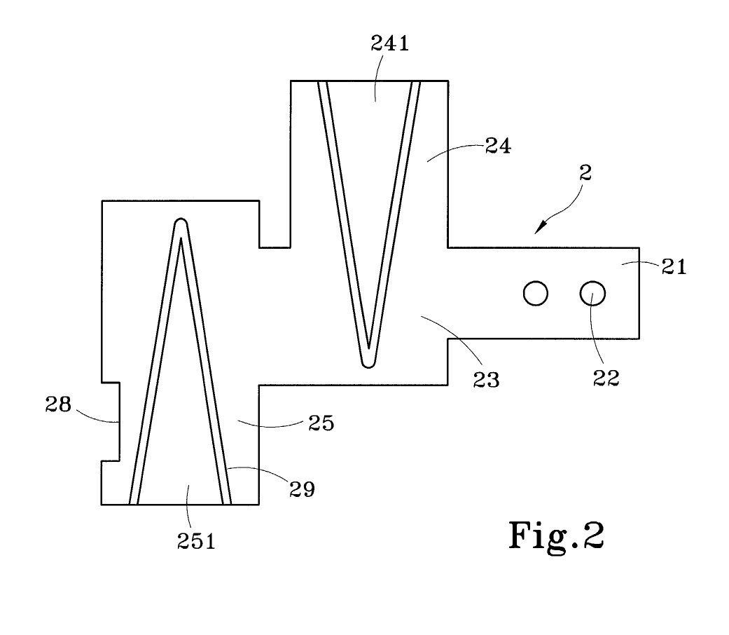

Referring to FIGS. 1 and 2, the anti-lock turning shaft of the invention consists of a shaft body 1 and a sleeve 2, and has a single element to perform positive and reverse turning, thereby allows dynamic frictional force approximately same as the static frictional force, therefore allows the gripping force reaching a natural balance, thus increase useful life. The positive and the reverse turning on the same element generates a loose and a tight condition and can prevent a locked phenomenon from happening, therefore allows the installation main body to avoid damage.

The shaft body 1 has a first anchor section 11 which has a first aperture 12 for fastening to the installation main body (not shown in the drawings). The first anchor section 11 has one end connected to a halt section 13 which has a jutting block stub 14. The halt section 13 connects a spindle 15 which may be pivotally coupled with the sleeve 2. The spindle 15 has at least one first oil groove 16 for containing lube oil therein.

The sleeve 2 has a second anchor section 21 which has a second aperture 22 for fastening to the installation main body (not shown in the drawings). The second anchor section 21 has one end connected to a pivotal section 23 which in turn connects a first elastic section 24 and a second elastic section 25 of same width or different widths. The first and second elastic sections 24, 25 have respectively a first end 241 and a second end 251 which are spaced from the pivotal section 23 to form respectively a first space 26 and a second space 27 which are changeable. The second elastic section 25 has one end formed an indented recess 28 to provide the block stub 14 an operation space. The inner wall of the pivotal section 23 has at least one second oil groove 29 for containing lube oil therein. Thus form a novel anti-lock turning shaft for positive and reverse rotation on a single element

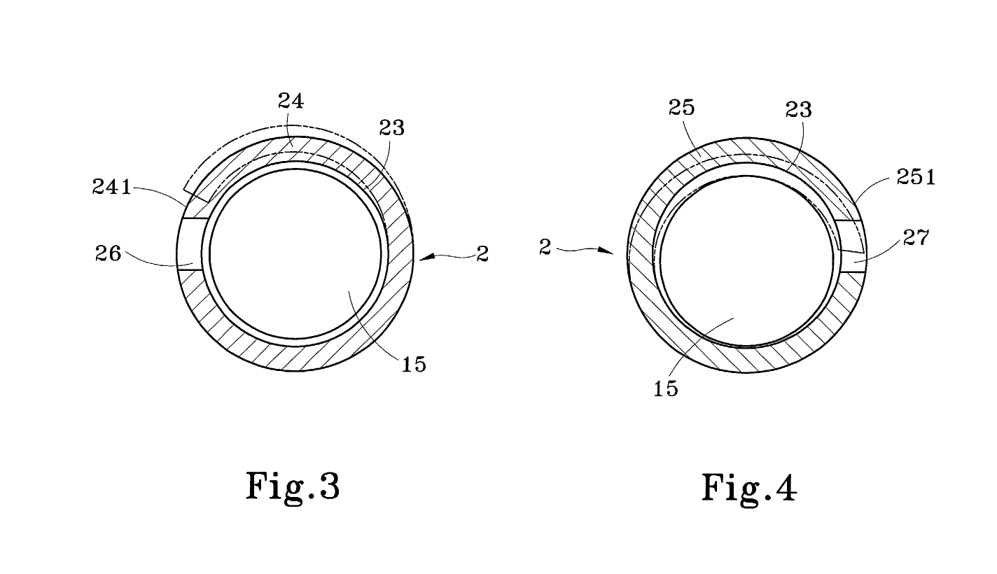

Referring to FIGS. 3 and 4, the first anchor section 11 of the shaft body 1 may be fastened to the display screen (or processor) of a notebook computer, and the sleeve 2 may be fastened to the processor (or display screen) of the notebook computer, and with the spindle 15 pivotally and tightly coupled in the sleeve 2. When the display screen (not shown in the drawings) of the notebook computer is opened, the spindle 15 in the pivotal section 23 is at a turning condition, the peripheral surface of the spindle 15 and the inner walls of the first and second elastic sections 24, 25 form a static friction relationship. As a result, the first space 26 between the first end 241 of the first elastic section 24 and the pivotal section 23 is stretched to form a larger interval and becomes a loose condition. In the mean time, the second space 27 between the second end 251 of the second elastic section 25 and the pivotal section 23 is contracted to form a smaller interval and becomes a tight condition. Therefore, the display screen of the notebook computer may be opened smoothly.

On the contrary, when the display screen of the notebook computer is at a closed condition, the interval between the second end 251 of the second elastic section 25 and the pivotal section 23 becomes larger and forms a loose condition, and the interval between the first end 241 of the first elastic section 24 and the pivotal section 23 becomes smaller and forms a tight condition, and the display screen of the notebook computer may be closed smoothly.

Based on the previous discussions, it is clear that the positive and reverse turning on a single element taking place on the first and second elastic sections 24, 25 generates a loose and a tight condition, thus can prevent the lock phenomenon from happening. And the display screen of the notebook computer may be opened and adjusted at any angle desired.

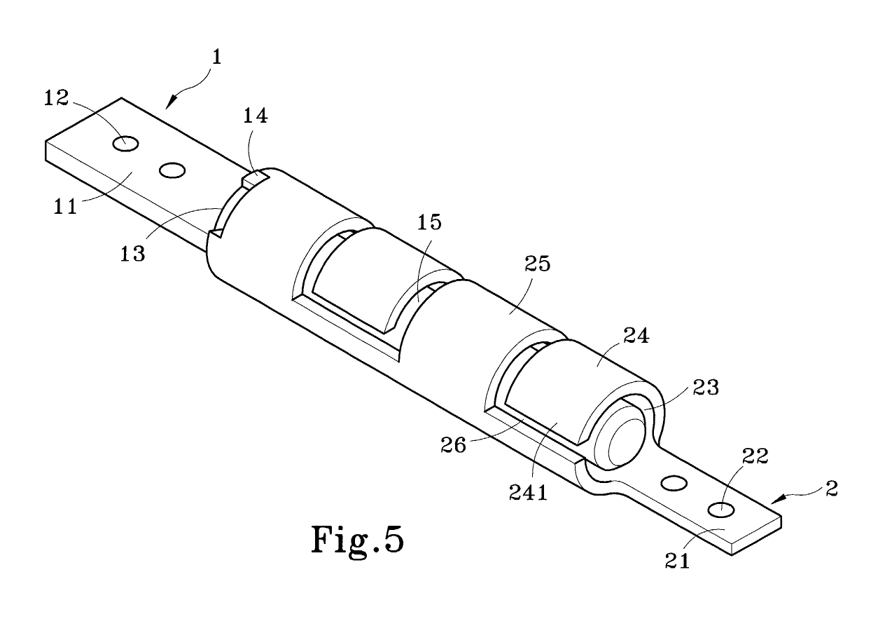

Referring to FIG. 5 for a second embodiment of the invention, it is largely constructed like the first embodiment shown in FIG. 1. The main difference is that the sleeve 2 has at least two sets of first and second elastic sections 24, 25 to allow the installation main body to open or close smoothly, and to prevent lock phenomenon from happening, thereby to avoid damaging the installation main body.

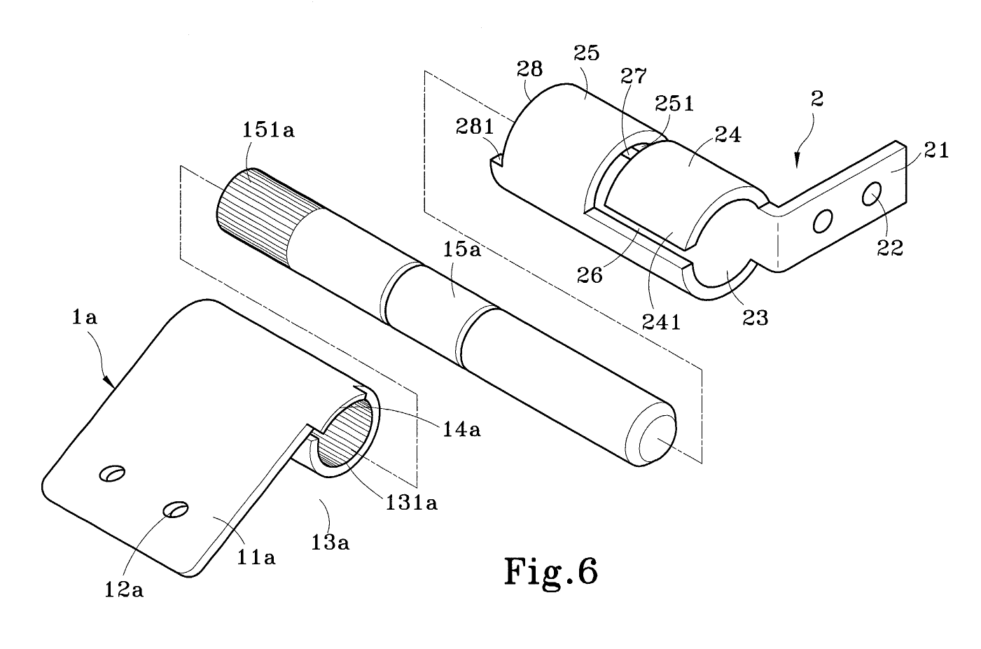

Referring to FIG. 6 for a third embodiment of the invention, it is largely constructed like the first embodiment shown in FIG. 1. The main difference is that the shaft body 1 is formed in a different shape 1a with a first anchor section 11a which has a first aperture 12a for fastening to the installation main body. The first anchor section 11a has one end connecting a coupling section 13a which has a block stub 14a jutting outwards on a selected location from a peripheral rim of the coupling section 13a. When the shaft body 1a is turned, the block stub 14a will be moved in the indented recess 28 of the second elastic section 25. The coupling section 13a has an inner wall formed a first spline surface 131a which may be coupled with a second spline surface 151a formed on the outer peripheral surface of the spindle 15a. Hence when the shaft body 1a is turned, the spindle 15a won't be turned in the coupling section but will be turned with the shaft body 1a. As the displacement of the block stub 14a is overlapped with the side end 281 of the indented recess 28, the elasticity may form a spring type hinge. Hence when the display screen and processor are at an unlatched condition, the display screen will be sprung upwards slightly for a selected height to form a gap with the processor to facilitate lifting of the display screen.

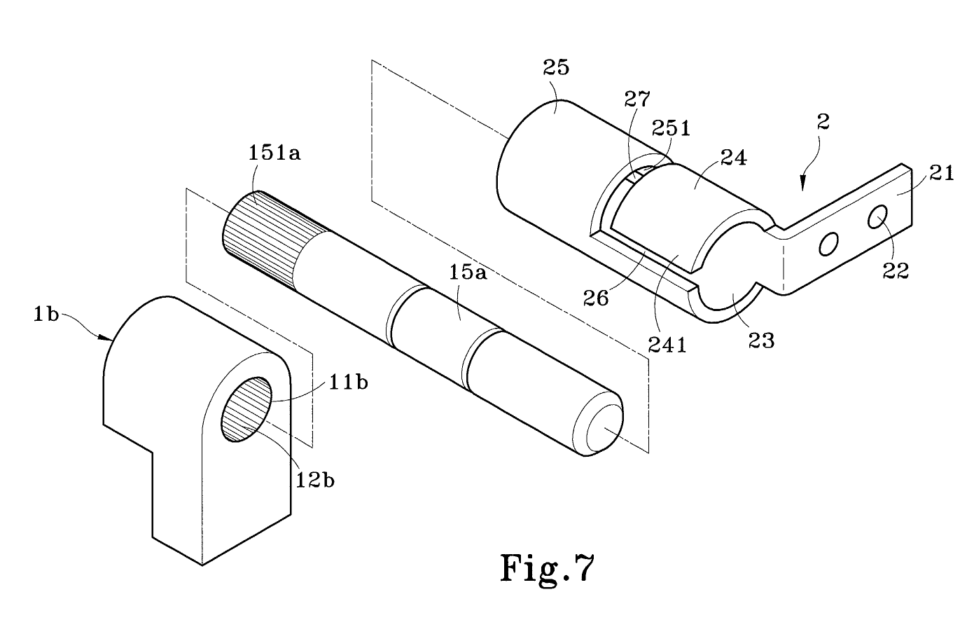

Referring to FIG. 7 for a fourth embodiment, it is largely constructed like the third embodiment shown in FIG. 6. The main difference is that the shaft body 1b has a coupling section 11b which has an inner wall formed a first spline surface 12b. The first spline surface 12b may be coupled with a second spline surface 151a formed at one end of the spindle 15a. When the shaft body 1b is turned, the spindle 15a won't be turned in the coupling section but will be turned with the shaft body 1a.

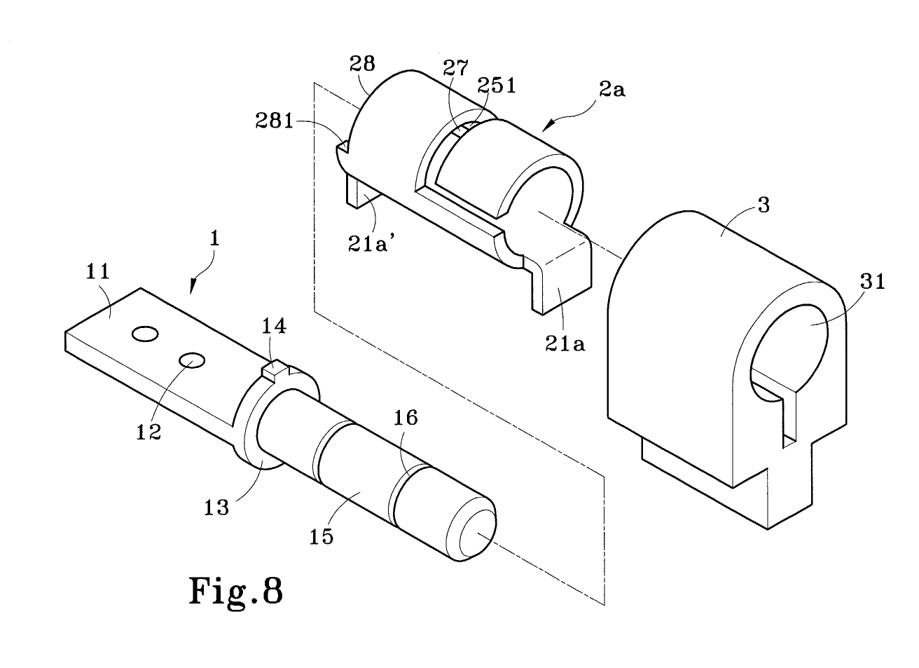

Referring to FIG. 8 for a fifth embodiment of the invention, it is largely constructed like the first embodiment shown in FIG. 1. The main difference is that the sleeve 2a has two sets of second anchor section 21a, 21a′. One second anchor section 21a′ forms a halt section to limit the turning range of the shaft body 1. A casing 3 is provided which has a housing chamber 31 for accommodating the sleeve 2a to form various anchoring conditions when assembled to the installation main body. Such a construction may prevent the sleeve 2a from external impacts or environmental influences, and may guard the sleeve 2a from damaging or losing turning function.

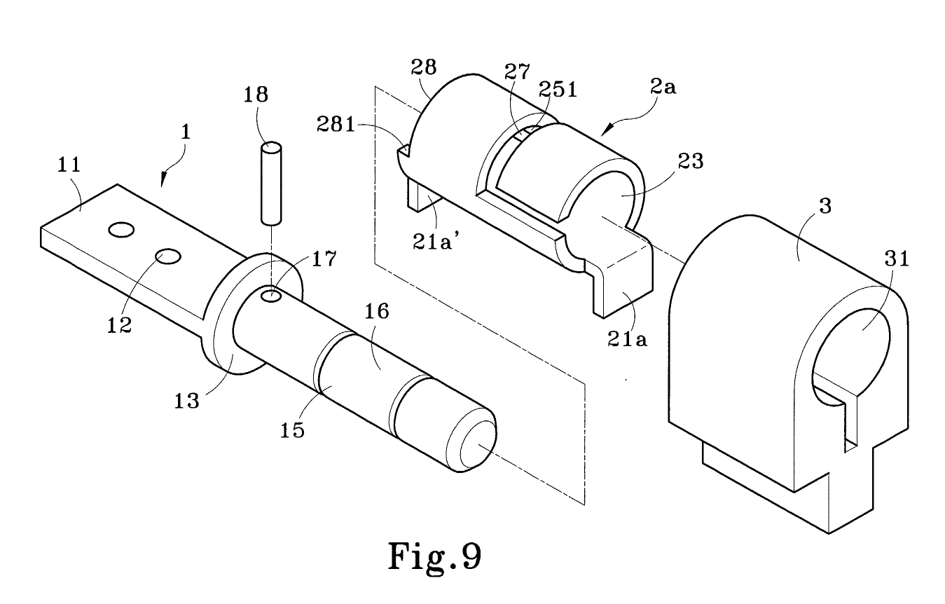

Referring to FIG. 9 for a sixth embodiment of the invention, it is largely constructed like the fifth embodiment shown in FIG. 8. The main difference is that the spindle 15 of the shaft body 1 has an aperture 17 to engage with a pin 18. When the shaft body 1 is turned, the displacement of the pin 18 is overlapped with that of the second anchor section 21a′, and through the elasticity of the second anchor section 21a′ to form a spring type hinge.

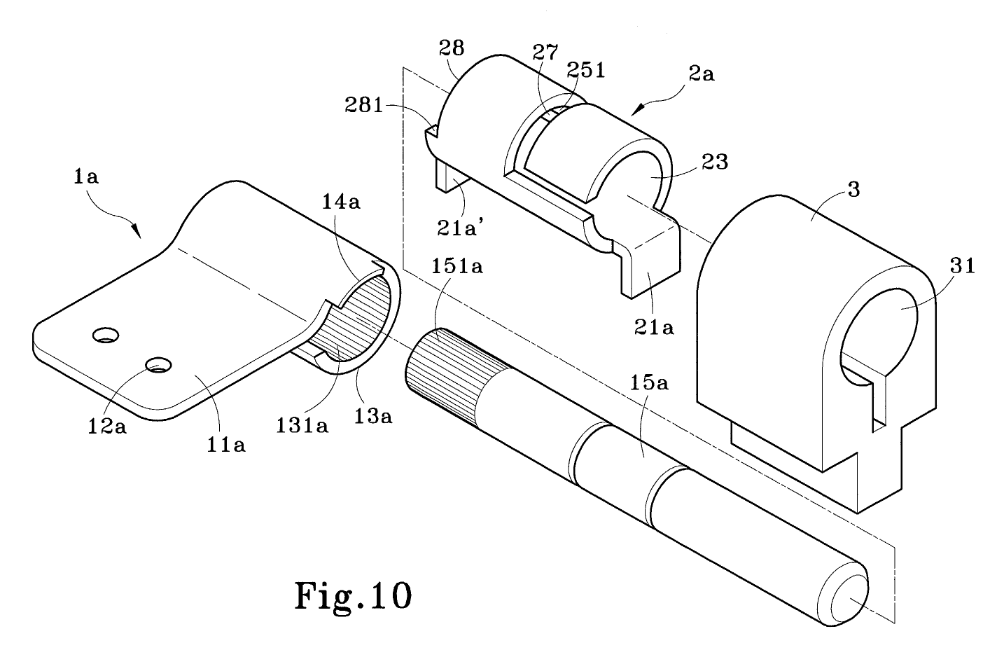

Referring to FIG. 10 for a seventh embodiment of the invention, it is largely constructed like the embodiments shown in FIGS. 8 and 9, the main difference is that the shaft body 1a and spindle 15a adopt similar designs as the ones shown in FIG. 6. These combinations can also form another type of anti-lock turning shaft for positive and reverse rotation on a single element structure. The block stub 14a and the second anchor section 21a′ have overlapped displacement, and through the elasticity of the second anchor section 21a′ to form a spring type hinge.

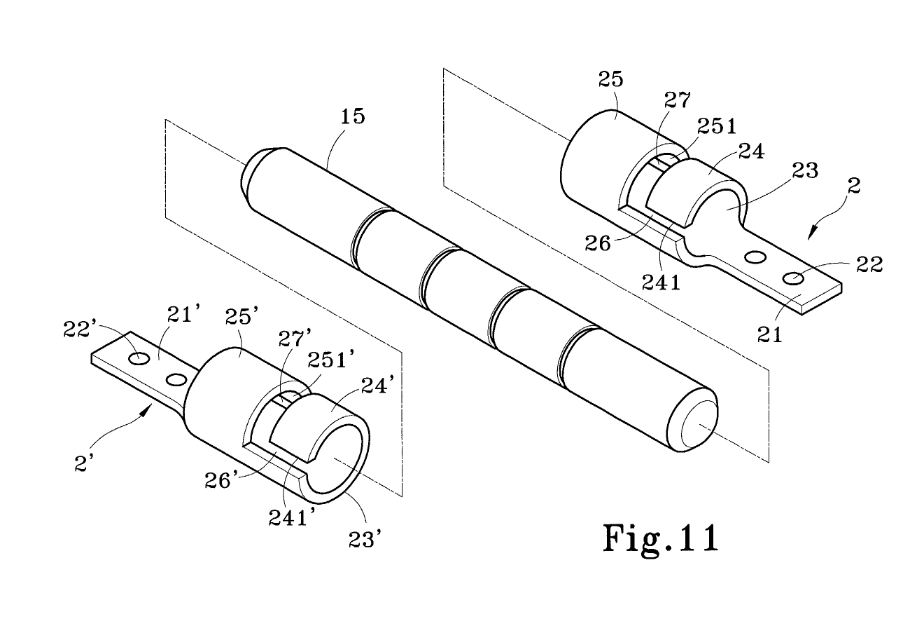

Referring to FIG. 11 for an eighth embodiment of the invention, it is largely constructed like the first embodiment shown in FIG. 1, the main difference is that two sets of sleeves 2, 2′ are used to couple with one spindle 15. The second sleeve 2′ has a second anchor section 21′ which has a second aperture 22′ to fasten to the display screen (or processor) of a notebook computer, the first sleeve 2 has a first anchor section 21 which has a first aperture 22 to fasten to the processor (or display screen) of the notebook computer. The spindle 15 is housed inside the sleeves 2, 2′. When the display screen (not shown in the drawings) of the notebook computer is opened, the spindle 15 is at a turning condition in the pivotal sections 23, 23′, the peripheral surface of the spindle 15 and the inner walls of the first and second elastic sections 24, 24′, 25, 25′ form a static friction relationship. As a result, the first spaces 26, 26′ between the first ends 241, 241′ of the first elastic sections 24, 24′ and the pivotal sections 23, 23′ are stretched to form larger intervals and become a loose condition. In the mean time, the second space 27, 27′ between the second ends 251, 251′ of the second elastic sections 25, 25′ and the pivotal section 23 are contracted to form smaller intervals to form a tight condition. Therefore, the display screen of the notebook computer may be opened smoothly.

On the contrary, when the display screen of the notebook computer is at a closed condition, the intervals between the second ends 251, 251′ of the second elastic sections 25, 25′ and the pivotal section 23 becomes larger and form a loose condition, and the intervals between the first ends 241, 241′ of the first elastic sections 24, 24′ and the pivotal section 23 become smaller and form a tight condition, and the display screen of the notebook computer may be closed smoothly.

Furthermore, the first and second elastic sections 24, 25 of the sleeve 2 may have different widths to generate different torque, thus may prevent the lock phenomenon from happening and to avoid damaging the installation main body.

What is claimed is:

1. An anti-lock turning shaft for positive and reverse turning on a single element, comprising:
a shaft body having a first anchor section which has at least one first aperture and one end connecting to a halt section, the halt section having a jutting block stub and connecting a spindle which has at least one first oil groove formed thereon; and
a sleeve having a second anchor section which has one end connecting to a pivotal section for pivotally coupling with the spindle, the pivotal section connecting a first elastic section and a second elastic section which have respectively one end spaced from the pivotal section to form a first space and a second space which are changeable;
wherein the first elastic section and the second elastic section form a positive and a reverse turning on same single element to prevent lock phenomenon from happening thereby to avoid an installation main body from damaging.

2. The anti-lock turning shaft for positive and reverse turning on a single element of claim 1, wherein the first elastic section and the second elastic element are selectively of same width or different widths, the second elastic section having one side formed an indented recess.

3. The anti-lock turning shaft for positive and reverse turning on a single element of claim 1, wherein the pivotal section has an inner wall which has at least one oil groove formed thereon.

4. The anti-lock turning shaft for positive and reverse turning on single element of claim 1, wherein the pivotal section has another end connecting to another anchor section.

5. The anti-lock turning shaft for positive and reverse turning on single element of claim 1 further having a casing which has a housing chamber for coupling with the sleeve.

6. The anti-lock turning shaft for positive and reverse turning on single element of claim 1, wherein the spindle has an aperture for housing a pin.

7. An anti-lock turning shaft for positive and reverse turning on a single element, comprising:
a shaft body having a first anchor section which has at least one first aperture and one end connecting to a coupling section, the coupling section having a jutting block stub and an inner wall formed a first spline surface;
a spindle having a second spline surface to couple with the coupling section; and
a sleeve having a second anchor section which has one end connecting to a pivotal section, the pivotal section connecting at least one first elastic section and one second elastic section which have respectively one end spaced from the pivotal section to form a first space and a second space which are changeable;
wherein the first elastic section and the second elastic section form a positive and a reverse turning on same single element to prevent lock phenomenon from happening thereby to avoid an installation main body from damaging.

8. The anti-lock turning shaft for positive and reverse turning on single element of claim 7 further having a casing which has a housing chamber for coupling with the sleeve.

9. A anti-lock turning shaft for positive and reverse turning on a single element, comprising:
a spindle; and
two sleeves each having an anchor section which has one end connecting to a pivotal section for pivotally coupling with the spindle, the pivotal section connecting at least one first elastic section and one second elastic section which have respectively one end spaced from the pivotal section to form a first space and a second space which are changeable;
wherein the first elastic section and the second elastic section form a positive and a reverse turning on same single element to prevent lock phenomenon from happening thereby to avoid an installation main body from damaging.
